(19) United States
(12) Patent Application Publication
(10) Pub. No.: US 2017/0136770 A1
(43) Pub. Date: May 18, 2017

(54) Droplet Deposition Apparatus

(71) Applicants: Simon James Hubbard, Bedfordshire (GB); Christopher James Gosling, Huntingdon (GB)

(72) Inventors: Simon James Hubbard, Bedfordshire (GB); Christopher James Gosling, Huntingdon (GB)

(21) Appl. No.: 15/318,815

(22) PCT Filed: Jul. 2, 2015
(86) PCT No.: PCT/GB2015/051940

§ 371 Date: Dec. 14, 2016

(30) Foreign Application Priority Data
Jul. 2, 2014 (GB) 1411842.6

(51) Int. Cl. B41J 2/14

(52) U.S. Cl. CPC B41J 2/14209; B41J 2002/14419

(57) ABSTRACT

A droplet deposition apparatus, such as an inkjet printhead, is disclosed. The apparatus includes an array of fluid chambers, where each chamber has a nozzle and a piezoelectric actuator element that causes droplets to be released on-demand from the nozzle in an ejection direction. The array of chambers extends in an array direction, which is perpendicular to the ejection direction. The apparatus also includes a common inlet manifold, which supplies fluid to the array of chambers, and may also include a common outlet manifold, which receives fluid from the array of chambers; both the inlet manifold and, where present, the outlet manifold are elongate in the array direction and extend the length of the array of chambers. The apparatus also includes a flow restrictor passage, which extends the length of the array of chambers in the array direction. This may either: connect the inlet manifold to the array of chambers so that during use fluid can flow along the length of the common inlet manifold, through the flow restrictor passage, then through said array of fluid chambers, and then into and along the length of said common outlet manifold; or, in situations where a common outlet manifold is provided, it may connect the array of chambers to the outlet manifold so that during use fluid can flow along the length of the common inlet manifold, through the array of fluid chambers, then through the first flow restrictor passage, and then into and along the length of the common outlet manifold. When a cross-section taken perpendicular to the array direction is viewed, the flow restrictor, and the manifold to which it is connected, are shaped such that the flow restrictor appears as a narrow, elongate passage linking that manifold to the chambers. The flow restrictor passage presents sufficient impedance to fluid flow such that, in use, fluid within it that is adjacent to the array of chambers is directed generally perpendicular to the array direction for substantially all of the chambers in the array.

The present invention relates to droplet deposition apparatus. It may find particularly beneficial application in a drop-on-demand ink-jet printhead, or, more generally, in droplet deposition apparatus and, specifically, in droplet deposition apparatus comprising: an array of fluid chambers, each chamber being provided with a nozzle and at least one piezoelectric actuator element operable to cause the release, on demand, of a droplet of fluid from the chamber through the nozzle, the array extending in an array direction; a common inlet manifold extending substantially the length of said array and being elongate in said array direction, for supplying fluid to said array of chambers; and a common outlet manifold extending substantially the length of said array and being elongate in said array direction, for receiving fluid from said array of chambers.

Those skilled in the art will appreciate that a variety of alternative fluids may be deposited by droplet deposition apparatus: droplets of ink may travel to, for example, a paper or other media, such as ceramic tiling, to form an image, as is the case in inkjet printing applications; alternatively, droplets of fluid may be used to build structures, for example electrically active fluids may be deposited onto media such as a circuit board so as to enable prototyping of electrical devices, or polymer containing fluids or molten polymer may be deposited in successive layers so as to produce a prototype model of an object (as in 3D printing). Droplet deposition apparatus suitable for such alternative fluids may be provided with modules that are similar in construction to standard inkjet printheads, with some adaptations made to handle the specific fluid in question.

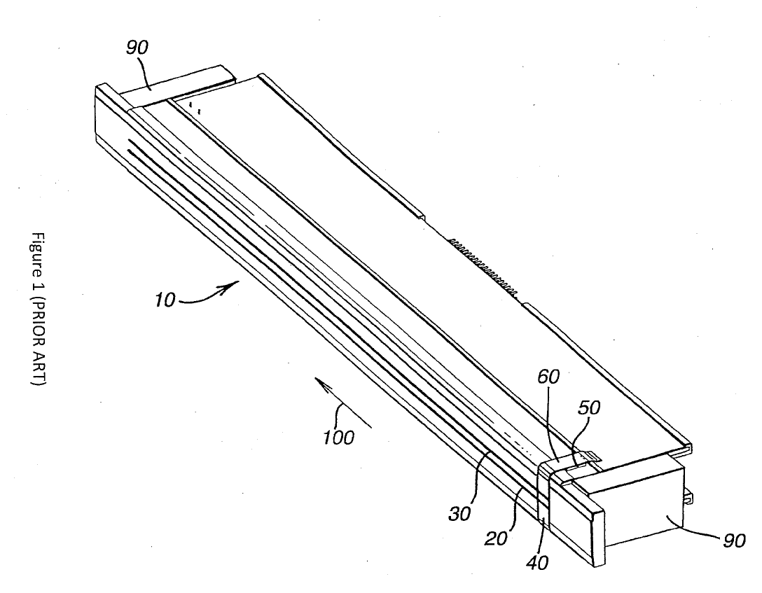

In addition, a wide variety of constructions exist within the prior art for droplet deposition, including a number that have been disclosed by the present Applicant. Of particular interest in the present case are the examples provided by WO 00/38928, from which FIGS. 1, 2, 3 and 4 are taken.

WO 00/38928 provides a number of examples of droplet deposition apparatus having an array of fluid chambers, with each chamber communicating with an orifice for droplet ejection, with a common fluid inlet manifold and with a common fluid outlet manifold and where there is, during use, a fluid flow into the inlet manifold, through each chamber in the array and into the outlet manifold.

FIG. 1 illustrates a “pagewide” printhead 10, having two rows of nozzles 20, 30 that extend in an array direction (indicated by arrow 100) the width of a piece of paper and which allow ink to be deposited across the entire width of a page in a single pass. Ejection of ink from a nozzle is achieved by the application of an electrical signal to actuation means associated with a fluid chamber communicating with that nozzle, as is known e.g. from EP-A-0 277 703, EP-A-0 278 590, WO 98/52763 and WO 99/19147.

More particularly, as taught in EP-A-0 277 703 and EP-A-0 278 590, piezoelectric actuator walls may be formed between successive channels and are actuated by means of electric fields applied between electrodes on opposite sides of each wall so as to deflect transversely in shear mode. The resulting pressure waves generated in the ink or other fluid cause ejection of a droplet from the nozzle.

To simplify manufacture and increase yield, the “pagewide” row(s) of nozzles may be made up of a number of modules, one of which is shown at 40, each module having associated fluid chambers and actuation means and being connected to associated drive circuitry (integrated circuit (“chip”) 50) by means e.g. of a flexible circuit 60. Ink supply to and from the printhead is via respective bores (not shown) in end-caps 90.

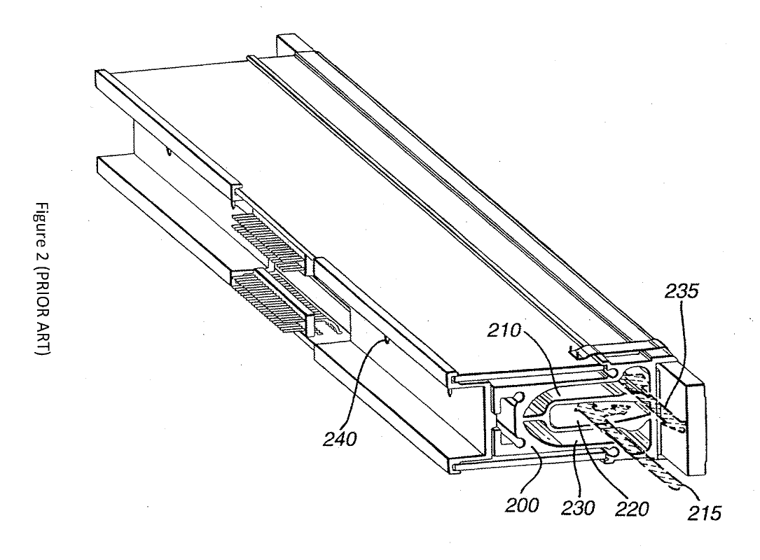

FIG. 2 is a perspective view of the printhead of FIG. 1 from the rear and with end-caps 90 removed to reveal the supporting structure 200 of the printhead incorporating ink flow passages, or manifolds 210,220,230 extending the width of the printhead. As may be send from FIG. 2, each of the manifolds is a chamber that is elongate in the array direction, indicated by 100 in FIG. 1; this arrangement provides a particularly compact printhead construction.

WO 00/38928 teaches that ink may be fed into an inlet manifold and out of an outlet manifold, with the manifolds being common to and connected via each channel, so as to generate ink flow through each channel (and thus past each nozzle) during printhead operation. This may act to prevent the accumulation of dust, dried ink or other foreign bodies in the nozzle that would otherwise inhibit ink droplet ejection.

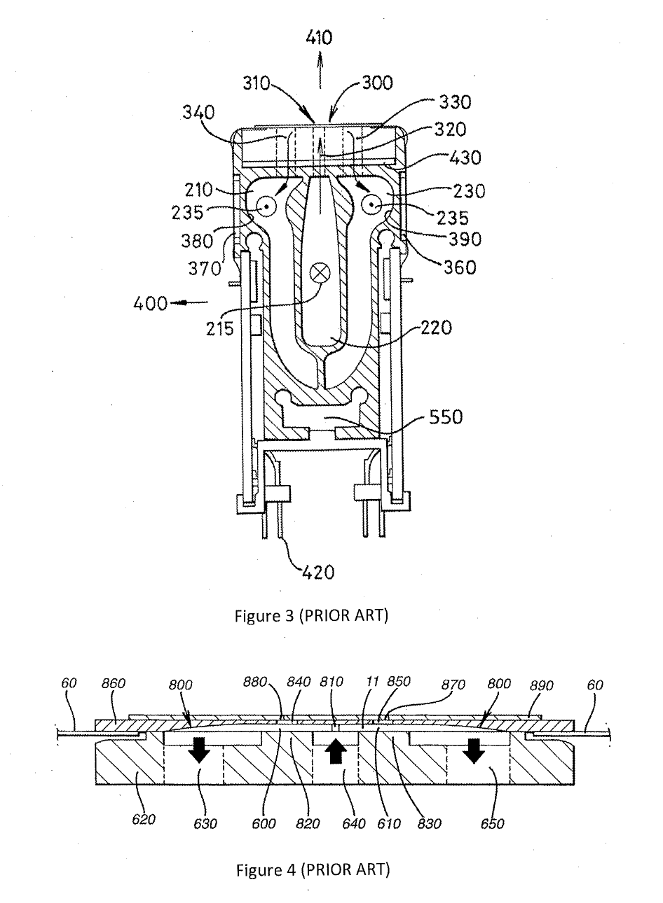

In more detail, ink enters the printhead of FIGS. 1 to 4 via a bore in one of the end-caps 90 (omitted from the views of FIGS. 1 and 2), and via the inlet manifold 220, as shown at 215 in FIG. 2. As it flows along the length of the inlet manifold 220, it is drawn off into respective ink chambers, as illustrated in FIG. 3, which is a sectional view of the printhead taken perpendicular to the direction of extension of the nozzle rows. From inlet manifold 220, ink flows into first and second parallel rows of ink chambers (indicated at 300 and 310 respectively) via aperture 320 formed in structure 200 (shown shaded). Having flowed through the first and second rows of ink chambers, ink exits via apertures 330 and 340 to join the ink flow along respective first and second ink outlet passages 210,230, as indicated at 235. These join at a common ink outlet bore (not shown) formed in the end-cap and that may be located at the opposite or same end of the printhead to that in which the inlet bore is formed.

Each row of chambers 300 and 310 has associated therewith respective drive circuits 360,370. The drive circuits are mounted in substantial thermal contact with that part of structure 200 acting as a conduit and which defines the ink flow passageways so as to allow a substantial amount of the heat generated by the circuits during their operation to transfer via the conduit structure to the ink. To this end, the structure 200 is made of a material having good thermal conduction properties. WO 00/38928 teaches that aluminum is a particularly preferred material, on the grounds that it can be easily and cheaply formed by extrusion. Circuits 360,370 are then positioned on the outside surface of the structure 200 so as to lie in thermal contact with the structure, thermally conductive pads or adhesive being optionally employed to reduce resistance to heat transfer between circuit and structure.

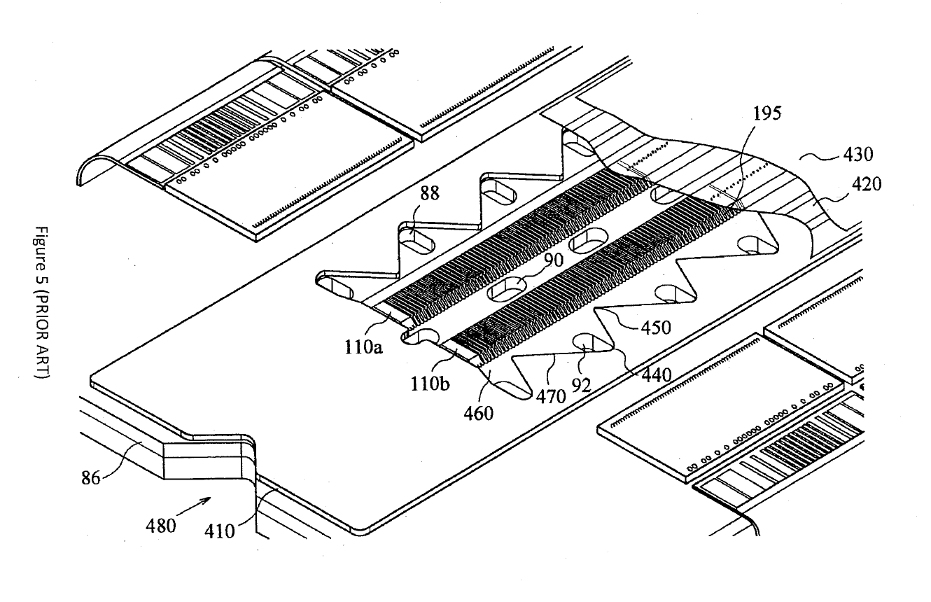

Further detail of the chambers and nozzles of the particular printhead shown in FIGS. 1 to 3 is given in FIG. 4, which is a sectional view taken along a fluid chamber of a module 40. As shown in FIG. 4, channels 11 are machined or otherwise formed in a base component 860 of piezoelectric material so as to define piezoelectric channel walls which are subsequently coated with electrodes, thereby to form channel wall actuators, as known e.g. from EP-A-0 277 703. Each channel half is closed along a length 600,610 by respective sections 820,830 of a cover component 620 which is also formed with ports 630,640,650 that communicate with fluid manifolds 210,220,230 respectively. Each half 600,610 of the channel 11 thus provides one fluid chamber.

A break in the electrodes at 810 allows the channel walls in either half of the channel to be operated independently by means of electrical signals applied via electrical inputs (flexible circuits 60). Ink ejection from each channel half is via openings 840,850 that communicate the channel with the opposite surface of the piezoelectric base component to that in which the channel is formed. Nozzles 870,880 for ink ejection are subsequently formed in a nozzle plate 890 attached to the piezoelectric component.

The large arrows in FIG. 4 illustrate (from left to right): the flow of fluid from the chambers on the left-hand-side of the array 600 to outlet manifold 210, via the left-hand port 630; the flow of fluid into the channels from inlet manifold 220, via the central port 640; and the flow of fluid from the chambers on the right-hand-side of the array 610 to the other outlet manifold 230, via the right-hand port 650.

As a result, it will be appreciated that there is, during use of the printhead, a flow of fluid along the length of each of the chambers 600,610. As noted above, WO 00/38928 teaches that this ink flow through each channel (and thus past each nozzle) during printhead operation may act to prevent the accumulation of dust, dried ink or other foreign bodies in the nozzle that would otherwise inhibit ink droplet ejection. More, WO 00/38928 teaches that, to ensure effective cleaning of the chambers by the circulating ink and in particular to ensure that any foreign bodies in the ink, e. g. dirt particles, are likely to go past a nozzle rather than into it, the ink flow rate through a chamber must be higher than the maximum rate of ink ejection from the chamber and may, in some cases, be ten times that rate.

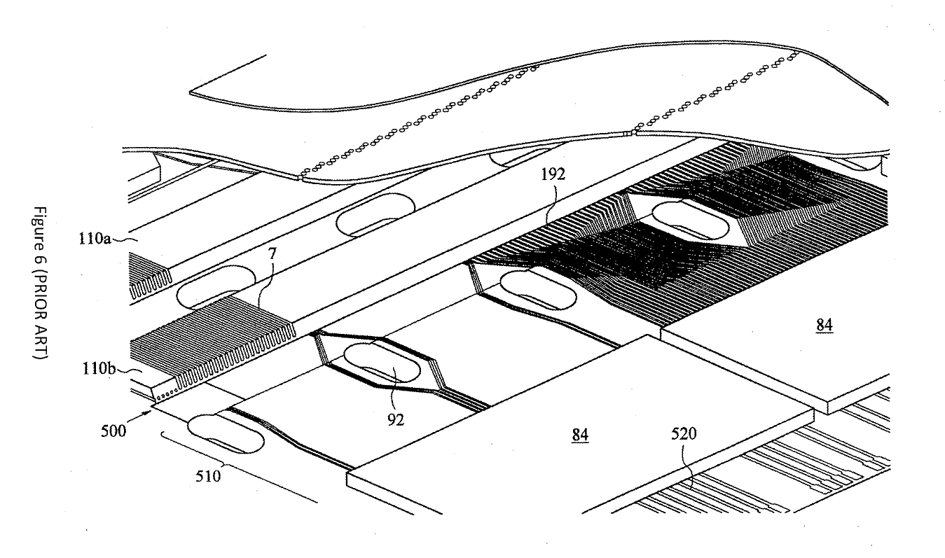

FIGS. 5 and 6 are exploded perspective views (taken from WO 01/12442) of a printhead having similar features as that shown in FIGS. 1 to 4. Thus, WO 01/12442 provides further examples of droplet deposition apparatus having an array of fluid chambers, with each chamber communicating with an orifice for droplet ejection, with a common fluid inlet manifold and with a common fluid outlet manifold and where there is, during use, a fluid flow into the inlet manifold, through each chamber in the array and into the outlet manifold.

FIGS. 5 and 6 illustrate in detail how various components may be arranged on a substrate 86, together with constructional details of the substrate 86 itself.

In more detail, FIGS. 5 and 6 illustrate two rows of channels spaced relative to one another in the media feed direction. The two rows of channels are formed in respective strips of piezoelectric material 110a, 110b, which are bonded to a planar surface of substrate 86. Each row of channels extends the width of a page in a direction transverse to the media feed direction. As discussed above, electrodes are provided on the walls of the channels, so that electrical signals may be selectively applied to the walls. The channel walls may thus act as actuator members that can cause droplet ejection.

Substrate 86 is formed with conductive tracks 192, which are electrically connected to the respective channel wall electrodes, (for example by solder bonds), and which extend to the edge of the substrate (86) where respective drive circuitry (integrated circuits 84) for each row of channels is located.

As may also be seen from FIGS. 5 and 6, a cover member 420 is bonded to the tops of the channel walls so as to create closed, “active” channel lengths which may contain pressure waves that allow for droplet ejection. Holes are formed in cover member 420 that communicate with the channels to enable ejection of droplets. These holes in turn communicate with nozzles (not shown) formed in a nozzle plate 430 attached to the planar cover member 420. However, it is also known, for example from WO 2007/113554, to use an appropriately constructed nozzle plate in place of such a combination of a cover member and nozzle plate.

As with the construction described with reference to FIGS. 1 to 4, the substrate 86 is provided with ports 88, 90 and 92, which communicate to inlet and outlet manifolds. The inlet manifold may be provided between two outlet manifolds, with the inlet manifold thus supplying ink to the channels via port 90, and ink being removed from the two rows of channels to respective outlet manifolds via ports 88 and 92. As FIG. 6 illustrates, the conductive tracks 192 may be diverted around the ports 88, 90 and 92.

As may be seen in FIGS. 5 and 6, the ports 90 communicating with the inlet manifold are arranged as an array that extends parallel to the direction of the nozzle rows (the array direction); similarly, the ports 88 communicating with the left-hand outlet manifold 210 and the ports 92 communicating with the right-hand outlet manifold 230 are arranged in respective arrays also extending parallel to the array. These arrays of ports 88, 90, 92 assist in changing the direction of the flow from one generally parallel to the nozzle row, or array direction, to one generally perpendicular to the array direction and therefore directed along the lengths of the fluid chambers.

In droplet deposition apparatus it is generally desirable to improve the uniformity over the length of the array of the droplets deposited; this is particularly the case with droplet deposition apparatus that have a large array of fluid chambers, such as inkjet printers. Where media is indexed past the array of fluid chambers to produce a pattern of droplets on the media (for example forming an image on a sheet of paper or a ceramic tile) such non-uniformity over the length of the array may be particularly visible, since it will produce generally linear defects extending in the direction of substrate movement, the human eye being particularly adept at identifying such linear features.

However, even where the pattern formed is not intended to be viewed by the human eye (such as where electrically active fluids are deposited onto media such as a circuit board so as to enable prototyping of electrical devices, or polymer containing fluids or molten polymer may be deposited in successive layers so as to produce a prototype model (so-called 3D printing)), or where the media is not indexed past the array, it will still be appreciated that non-uniformity over the length of the array will be a concern.

There are numerous factors that are thought to cause non-uniformity of deposited droplets, with the interactions between these factors complex and often difficult to predict. Embodiments of the present invention may therefore exhibit improved uniformity in droplet deposition over the array of fluid chambers. However, it should be noted that further and/or other advantages may stem from embodiments of the present invention.

Thus, in accordance with a first aspect of the present invention there is provided droplet deposition apparatus comprising: an array of fluid chambers, each chamber being provided with a nozzle and at least one piezoelectric actuator element operable to cause the release, on demand, of a droplet of fluid from the chamber through the nozzle in an ejection direction, the array extending in an array direction, substantially perpendicular to said ejection direction; a common inlet manifold extending at least substantially the length of said array and being elongate in said array direction, for supplying fluid to said array of chambers; a common outlet manifold extending at least substantially the length of said array and being elongate in said array direction, for receiving fluid from said array of chambers; and a first flow restrictor passage connecting said array of chambers to one of said common inlet manifold and said common outlet manifold, so as to enable, respectively: a flow of fluid during use of the apparatus along the length of said common inlet manifold, through said first flow restrictor passage, then through said array of fluid chambers, and then into and along the length of said common outlet manifold; or a flow of fluid during use of the apparatus along the length of said common inlet manifold, through said array of fluid chambers, then through said first flow restrictor passage, and then into and along the length of said common outlet manifold; wherein said first flow restrictor passage extends substantially the length of said array in said array direction;

wherein said one of the common inlet manifold and the common outlet manifold, and said first flow restrictor passage are shaped such that said first flow restrictor passage appears as a narrow, elongate passage leading from or to respectively said one of the common inlet manifold and the common outlet manifold, when viewed in cross-section perpendicular to the array direction; and

wherein said first flow restrictor passage presents sufficient impedance to fluid flow such that, in use, fluid within said first flow restrictor passage adjacent said array of chambers is directed generally perpendicular to said array direction for substantially all the chambers within the array.

The Applicant has identified variation in flow distribution over the length of the array as being a factor that may have a significant effect upon the uniformity of the droplets deposited by the array. More particularly, in apparatus where there is a common inlet manifold extending substantially the length of said array and being elongate in said array direction, for supplying fluid to said array of chambers and a common outlet manifold extending substantially the length of said array and being elongate in said array direction, for receiving fluid from said array of chambers, the flow of fluid within such common manifolds will generally be parallel to the array direction. However, if the flow adjacent the array of fluid chambers is also generally parallel to the array direction, the distribution of the flow over the chambers within the array may be poor. Measures have therefore been taken in prior art constructions to alter the direction of the flow adjacent to the array of chambers so that it is closer to perpendicular to the array direction.

For example, as noted above, WO 00/38928 provides arrays of ports 88, 90, 92 that assist in changing the direction of the flow from one generally parallel to the nozzle row, or array direction, to one generally perpendicular to the array direction and therefore directed along the lengths of the fluid chambers. However, drawbacks exist with such constructions; in particular, the chambers closest to the ports 88, 90, 92 are found to generally receive relatively more flow, whereas the chambers more distant to the ports 88, 90, 92 are found to generally receive relatively less flow. In addition, the flow distribution may be relatively sensitive to variations in the size and/or shape of the ports 88, 90, 92. Further, the overall construction may be relatively complex and costly to produce, involving a number of separate components that must be assembled.

Other approaches are disclosed in WO 2005/007415, also belonging to the present Applicant. Specifically, a construction is disclosed where inlet and outlet plenum chambers are provided on either side of an array of ejection chambers spaced in an array direction. The inlet manifold, which extends in the array direction, communicates with the inlet plenum chamber through a porous sheet. Similarly, the outlet plenum chamber communicates with the outlet manifold, which also extends in the array direction, through the same porous sheet. In use of the apparatus there is a flow of fluid between the inlet manifold and the outlet manifold through the chambers. The porous element is designed, for example by the use of a sintered ceramic material, to provide the dominant pressure drop in this flow. As a result, whilst there may be substantial net ink flows in the array direction in the inlet and the outlet manifolds, the document suggests that there is substantially no net flow in the array direction in the inlet or outlet plenum chamber.

However, drawbacks exist with such constructions also. More particularly, the large pressure drop across the porous element may cause the apparatus to present a large overall impedance to fluid flow, which may necessitate the use of complex and costly fluid supply systems. Specifically, it has been found the pressure differential required to provide desirable flow rates through such constructions (which may act to prevent the accumulation of dust, dried ink or other foreign bodies in the nozzle that would otherwise inhibit droplet deposition, as taught by WO 00/38928) may be so large that gravity-based fluid supply systems, where the pressure differential is provided by suitable differentials in height between fluid reservoirs and the array of nozzles, are no longer practical. For example, the height differential required may be several metres, or more, thus making the overall size of the apparatus unacceptably large. Further, the porous sheet, or other porous elements taught by the document may progressively and irreversibly block up with particles suspended within the fluid (for example, in the case of ink, pigment particles), with these particles becoming lodged within and on the surfaces of the porous element. Furthermore, the overall construction may be relatively complex and costly to produce, involving a number of separate components that must be assembled. In particular, providing a porous element that is sufficiently robust and homogenous may be challenging in practice. In addition, it may be difficult to form the plenum chambers taught by WO 2005/007415.

According to the present invention, the first flow restrictor passage presents sufficient impedance to fluid flow such that, in use, fluid within the first flow restrictor passage adjacent said array of chambers is directed generally perpendicular to the array direction at substantially all the chambers within the array. As the first flow restrictor passage extends substantially the length of said array in said array direction, there may be less local variation in flow rates, as compared to the constructions disclosed in WO 00/38928, where ports are utilised. Further, manufacturing a passage and specifically a passage that extends substantially the length of the chamber array may be relatively straightforward (for example by machining or moulding components). More generally, manufacturing apparatus according to the present invention may involve the assembly of fewer and/or less costly components.

In embodiments, the flow restrictor passage may described as being connected directly to both the array of fluid chambers and one of the common inlet manifold and the common outlet manifold. Hence, or otherwise, one end of the flow restrictor passage may open into said of the common inlet manifold and the common outlet manifold, while the other end of the flow restrictor passage may open into the array of fluid chambers. In embodiments of the invention, the flow restrictor passage may have the same cross-section for substantially its whole length in the array direction. Such embodiments may be particularly straightforward to manufacture and may provide particularly consistent behaviour over its length in the array direction in terms of modifying fluid flow.

The Applicant considers that the principles discussed above with regard to the flow restrictor passage may also be applied in apparatus not necessarily provided with an outlet manifold. Therefore, according to a further aspect of the invention there is provided a droplet deposition apparatus comprising: an array of fluid chambers, each chamber being provided with a nozzle and at least one piezoelectric actuator element operable to cause the release, on demand, of a droplet of fluid from the chamber through the nozzle in an ejection direction, the array extending in an array direction, substantially perpendicular to said ejection direction; a common inlet manifold for supplying fluid to said array of chambers, the common inlet manifold extending substantially the length of said array and being elongate in said array direction, so as to enable a flow of fluid during use of the apparatus along the length of said common inlet manifold; and a flow restrictor passage connecting said common inlet manifold to said array of chambers, the first flow restrictor passage extending substantially the length of said array in said array direction; wherein said common inlet manifold and said first flow restrictor passage are shaped such that said first flow restrictor passage appears as a narrow, elongate passage leading from the common inlet manifold, when viewed in cross-section perpendicular to the array direction; and wherein said first flow restrictor presents sufficient impedance to fluid flow such that, in use, fluid within said first flow restrictor adjacent said array of chambers is directed generally perpendicular to said array direction for substantially all the chambers within the array.

The present invention will now be described with reference to the accompanying drawings, in which:

FIG. 1 is a perspective view of a prior art “pagewide” printhead taken from WO 00/38928;

FIG. 2 is a perspective view from the rear and the top of the printhead of FIG. 1;

FIG. 3 is a sectional view of the printhead of FIGS. 1 and 2 taken perpendicular to the direction of extension of the nozzle rows;

FIG. 4 is a section view taken along a fluid channel of an ink ejection module of the printhead of FIG. 2;

FIGS. 5 and 6 are perspective and detail perspective views respectively of a printhead disclosed in WO 01/12442 that illustrate how various features and components may be provided on a substrate;

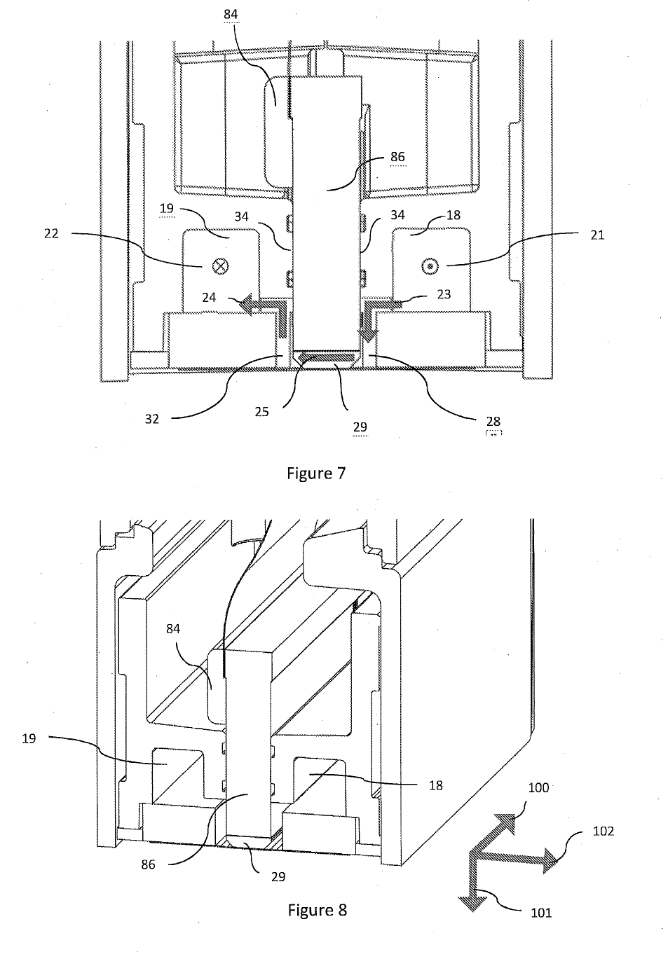

FIG. 7 is a cross-sectional view taken in the direction of an array of fluid chambers of a printhead according to an embodiment of the invention;

FIG. 8 is an isometric view of the cross-section of the printhead shown in FIG. 7;

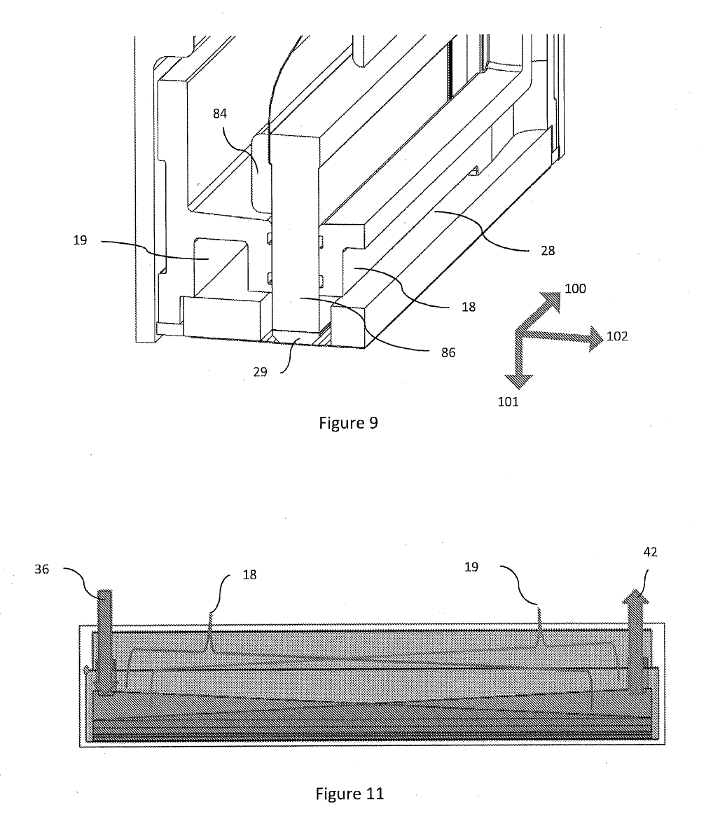

FIG. 9 is an isometric view of the printhead shown in FIGS. 7 and 8, with sections taken perpendicular and parallel to the length of one of the manifold chambers;

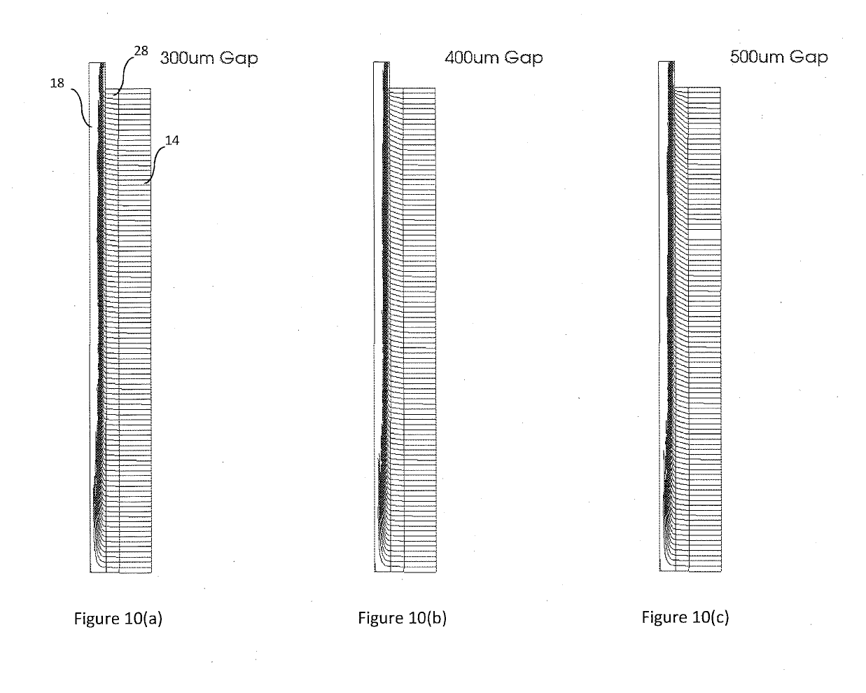

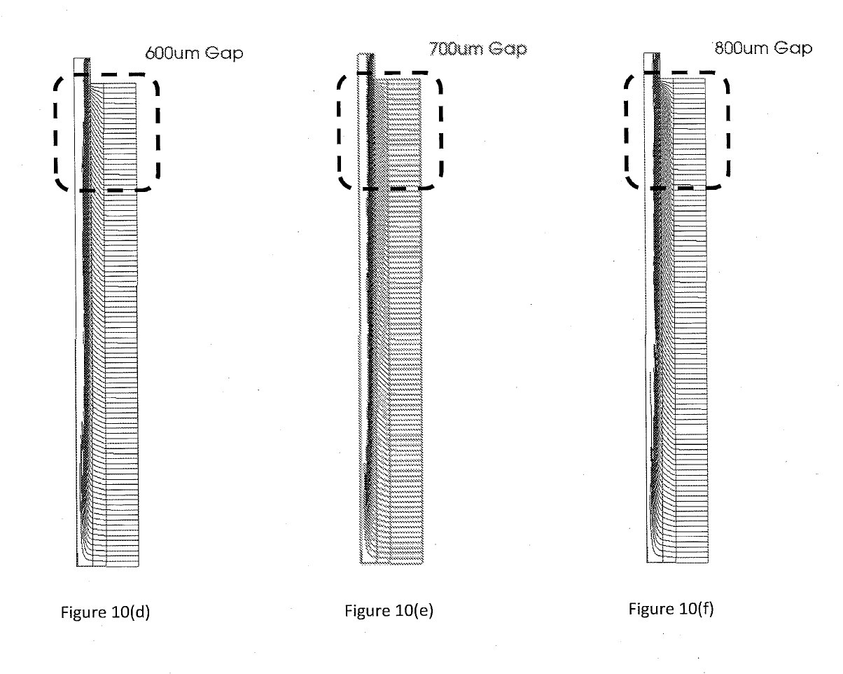

FIG. 10 illustrates the results of fluid flow modeling tests carried out on printhead designs similar to those shown in FIGS. 7 to 9, with inlet flow restrictor passages of varying widths;

FIG. 11 is a side plan view of the manifold component for the printhead illustrated in FIGS. 7 to 9;

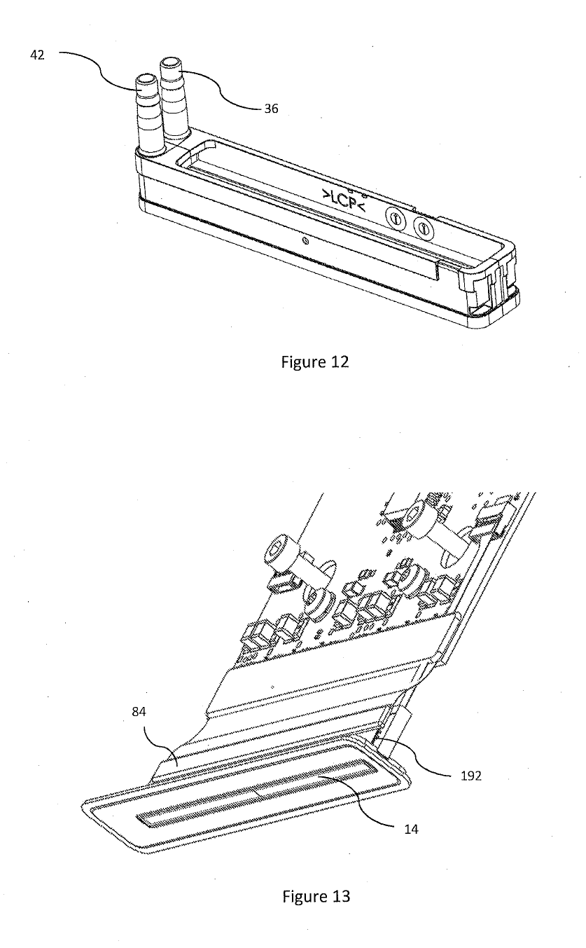

FIG. 12 is an isometric view of a manifold component for a printhead according to a further embodiment;

FIG. 13 is an isometric view of certain interior components of the printhead of FIGS. 7 to 9; and

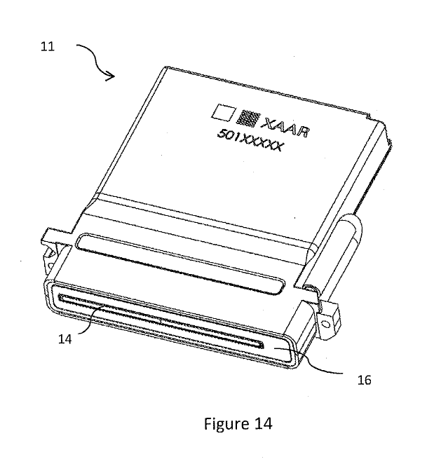

FIG. 14 is an isometric view of the fully-assembled printhead of FIGS. 7 to 9 and 13.

The present invention may be embodied in a printhead and, more specifically, an inkjet printhead. FIG. 7 shows a plan view of a cross-section of an inkjet printhead according to an embodiment of the present invention, the cross-section being taken perpendicular to the direction in which the array of fluid chambers (14) in the printhead extends.

As may be seen from FIG. 7, the printhead is provided with only one array of fluid chambers that extends in an array direction (100) (generally into the paper in the drawing). Each of the fluid chambers is elongate in a chamber extension direction (102), which is perpendicular to this array direction (100) (though it will be appreciated that in alternative embodiments the chamber extension direction (102) could vary by 10 or 20 degrees from perpendicular, or indeed some other value). Although not immediately visible in the cross-sectional view of FIG. 7, each fluid chamber within the array is an elongate open-topped channel formed in the top surface of a strip of piezoelectric material, for example lead zirconium titanate (PZT). This strip of piezoelectric material is in turn provided on the edge surface of a substrate member (86), which is elongate in the array direction (100), extending beyond both ends of the array of fluid chambers (14). The substrate member (86) may suitably be formed of a ceramic material, such as alumina. Each of these fluid channels is therefore bounded by two elongate walls of piezoelectric material; the channels extend side-by-side in an array extending in the array direction (100).

On opposite channel-facing surfaces of the piezoelectric walls are arranged electrodes to which voltages can be applied via connections provided on the side surfaces (34) of the substrate member (86). These side surfaces may be seen more clearly in FIG. 8, which is an isometric view of the cross-section shown in FIG. 7. As is known, e. g. from EP-A-0 364 136, application of an electric field between the electrodes on either side of a wall results in shear mode deflection of the wall into one of the flanking channels, which in turn generates a pressure pulse in that channel.

As is also shown by FIGS. 7 and 8, the channels are closed by a cover member in which are formed nozzles, each communicating with respective channels at the mid-points thereof. Droplet release from the nozzles takes place in response to the aforementioned pressure pulse, as is well known in the art. As may be apparent from FIG. 8, the direction in which droplets are ejected—the ejection direction (101)—is generally downwards in the drawing. As is visible in the cross-sectional view of FIG. 8, the substrate member (86) is elongate in this ejection direction (101). Accordingly, the piezoelectric actuator members may be seen as being provided on the long “edge” of the substrate member (86), since the edge surface of the actuator block, in which the channels providing fluid chambers are formed, is defined by the longest and the shortest dimensions of the actuator block (which extend, respectively, in the array direction (100) and the chamber extension direction (102)). Accordingly, such embodiments may be referred to as “edge-shooters”, in contrast to embodiments where the fluid chambers are provided on the side surface (34) of a substrate member (86), which may typically be referred to as “side-shooters”.

The electrical connections on the side surfaces (34) of the substrate member (86) are provided by conductive tracks (192), which lead to integrated drive circuitry (84) disposed towards the top of the side surface (34). A flexible connector extends away from the drive circuitry (84), as is shown in FIG. 8, so as to link the drive circuitry (84) with further electronic components not visible in FIG. 8.

As is also visible in FIGS. 7 and 8, the edges of the strip of piezoelectric material are chamfered. This may simplify the provision of the channel electrodes and the conductive tracks (192) on the side surface (34): following the formation of the channels in the strip of piezoelectric material (for example by disc cutting), a metallic layer may be deposited over both the surfaces of the strip of piezoelectric material and the side surfaces (34) of the substrate member (86); this metallic layer may then be patterned appropriately, for example using a laser, so as to provide integrally formed channel electrodes and tracks (192). The chamfer may enable the patterning of the edges of the strip of piezoelectric material to be carried out more accurately.

As is shown in FIGS. 7 and 8, having only one array of actuators, the printhead is provided with a single inlet manifold chamber (18) and a single outlet manifold chamber (19), which each extend the length of the array of fluid chambers (14) in the array direction (100) (generally into the paper in the drawing). Each of the manifold chambers is common to all of the chambers within the array; each of the chambers is fluidically connected in series with all of the chambers in the array. As may be seen, the inlet and outlet manifold chambers (19,18) are provided on either side of the substrate member (86) with respect to the array direction (100).

Further details of the manifold chambers will be apparent from FIG. 9, which is an isometric view of the printhead of FIGS. 7 and 8, with sections taken perpendicular to the array direction (100), as in FIGS. 7 and 8, and an additional section taken along the length of the inlet manifold chamber (18). As may be seen, the inlet manifold chamber (18) extends beyond the end of array of fluid chambers. Though not shown, the outlet manifold chamber (19) in this embodiment also extends beyond the end of the array of fluid chambers. This may be found to reduce edge-effects, where there is greater variability in the properties of droplets deposited by those chambers towards the ends of the array.

In addition, there is displayed an inlet flow restrictor (28) passage that links the inlet manifold chamber (18) to the array of fluid chambers (14). A similar, outlet flow restrictor (32) passage is also indicated in the drawing and links the array of chambers (14) to the outlet manifold chamber (19). Both of these flow restrictor passages extend the length of the array of fluid chambers (14) and, as may be seen from the drawing, when a cross-section taken perpendicular to the array direction (100) is considered, they are relatively narrow in comparison to the manifold chambers and have an elongate cross-sectional shape. As may also be seen from the drawing, the inlet flow restrictor passage (28) is connected to one longitudinal end of each of the chambers in the array (14) and the outlet flow restrictor passage (32) is connected to the other longitudinal end of each of the chambers in the array (14).

In the specific embodiment shown in FIG. 8, the flow restrictor passages are formed as elongate slots that extend in both the array direction (100) and the ejection direction (101). Such slots are relatively straightforward to form, for example by using moulded components or machining. Elongation of the flow restrictor passages in the ejection direction (101) (as opposed to the chamber extension direction (102)) may enable the size of the printhead in the direction of substrate movement to be decreased.

The purpose of the flow restrictor passages may be better understood with the aid of FIG. 9, which is also a cross-sectional view through the printhead shown in FIG. 8, but shows the flows of fluid during use of the printhead, when connected to a suitable fluid supply.

As may be seen, there is a flow along the length of the inlet manifold chamber (18), in a direction into the page in the view of FIG. 9. The flow of fluid within the outlet manifold chamber (19) is directed in the opposite direction, out of the page in FIG. 9, and along the length of the outlet manifold chamber (19).

As may also be seen, while the flow (21, 22) in the inlet and outlet manifold chambers (19,18) is generally parallel to the array direction (100), the flow (23, 24) in the flow restrictor passages is generally perpendicular to the array direction (100). This is achieved by designing the flow restrictor passages so as to provide suitable impedance to fluid flow between the respective one of the inlet and outlet manifold chambers (19,18) and the array of fluid chambers (14). The effect of this impedance is to “turn” the direction of fluid flow from one that is parallel to the array direction (100) to one that is perpendicular to the array direction (100). More particularly, the impedance is such that the fluid flow is perpendicular to the array direction (100) for substantially all the chambers within the array.

The overall flow path is therefore from the inlet manifold chamber (18), generally in a direction parallel to the array direction (100), then into the inlet flow restrictor (28), generally in a direction perpendicular to the array direction (100), then into the fluid chambers, generally in the chamber extensions direction. Fluid in excess of that required for droplet deposition then flows to the outlet flow restrictor (32) in a direction generally perpendicular to the array direction (100), before emerging into the outlet manifold chamber (19), where it returns to flowing generally in a direction parallel to the array direction (100), though in the opposite direction to the flow (21) in the inlet manifold chamber (18).

In the embodiment shown in FIGS. 7, 8 and 9, the impedance to fluid flow of the flow restrictor channels is achieved simply by a suitable choice of the width of the flow restrictor passage. Apparatus with such flow restrictor passages are particularly straightforward to manufacture. More particularly, such flow restrictor passages may be formed with a high degree of accuracy over its length in the array direction (100) so as to have the desired effect on flow over the whole length in the array direction (100), which may be more difficult to achieve with more complex constructions.

On the other hand, it should be noted that protrusions or baffles within the flow restrictor passages may also be utilised to distribute the flow and/or alter the impedance of the flow restrictor passages.

The impedance necessary to achieve the particular flow patterns described above may vary depending on the particular construction of the droplet deposition apparatus. However, the general design considerations will typically be similar and will now be described with reference to FIGS. 10(a)-10(f).

FIGS. 10(a)-10(f) show the results of flow modeling tests carried out on the printhead design of FIGS. 8 and 9. More particularly, the drawing shows the streamlines of the flow through the inlet manifold chamber (18), the inlet flow restrictor (28) passage and the array of fluid chambers (14) during use of the printhead. For clarity, these features are flattened in the diagram.

As may be seen from the diagram, the effect of the inlet flow restrictor (28) is to cause fluid, which flows generally in the array direction (100) along the length of the inlet manifold chamber (18), to “turn” and be directed perpendicular to the array direction (100) as it approaches the array of fluid chambers (14). In the specific embodiment depicted in FIG. 10(a), the flow restrictor passage has a width of 300 microns, corresponding to an impedance of around 170 MPa/m³s⁻¹.

FIGS. 10(b)-10(f) then illustrate the results of similar modeling tests carried out on embodiments where the flow restrictor passage has a width of, respectively, 400, 500, 600 and 700 microns (corresponding, respectively, to impedances of around 91, 62, 49 and 42 MPa/m³s⁻¹).

As will be apparent from the streamlines visible in the dashed boxes of FIGS. 10(d) to (f), the streamlines closest to the inlet end of the inlet manifold chamber (18) start to become congested for a flow restrictor passage of width 700 microns or greater, rather than being evenly spaced, as with the flow restrictor passages shown in FIGS. 10(a) to 10(d).

Thus, in order to ensure that fluid within the flow restrictor passage (28) adjacent the array of chambers is generally evenly distributed for substantially all the chambers within the array (14), it may be appropriate to utilise a flow restrictor passage with a width of less than 700 microns. At this width, the ratio of the impedance over the length of the flow restrictor passage to the impedance over the length of the inlet manifold chamber (18) is approximately 1:85. Thus, even with a flow restrictor passage that provides a surprisingly small amount of impedance, there may be a beneficial effect in terms of modifying the direction of the fluid flow adjacent the array of fluid chambers (14).

It should further be appreciated that the pressure drop over the flow restrictor passage is even smaller in comparison to the pressure drop across the array of fluid chambers (14). For the passage of 700 microns width, the ratio is approximately only 1:450. Thus the impedance of the flow restrictor is considerably less than that of the actuator. This may be contrasted with constructions disclosed in WO 2005/007415, where the porous element provides the dominant pressure drop in a flow of fluid between the inlet manifold and the outlet manifold through an array of fluid chambers (14).

For narrower flow restrictor passages (and therefore higher impedances) modeling tests indicate that the flow within the flow restrictor passage will begin to transition from laminar flow to turbulent flow. More particularly, modeling tests suggest that this transition begins to occur with passages having a width of less than 175 microns. This corresponds to a ratio for the impedance over the length of the flow restrictor passage to the impedance over the length of the inlet manifold chamber (18) of around 4:3, or an absolute impedance for the flow restrictor of 716 MPa/m³s⁻¹.

It should further be appreciated that, even with the relatively higher impedance of this flow restrictor passage, the pressure drop over the flow restrictor passage is nonetheless considerably smaller in comparison to the pressure drop across the array of fluid chambers. For the passage of 175 microns width, the ratio is still approximately only 1:15. Thus the impedance of the flow restrictor is still considerably less than that of the actuator. Again, this may be contrasted with constructions disclosed in WO 2005/007415, where the porous element provides the dominant pressure drop in a flow of fluid between the inlet manifold and the outlet manifold through an array of fluid chambers. Thus, providing a suitable fluid supply for apparatus according to embodiments of the present invention may be significantly easier.

More generally, while in the embodiments discussed with reference to FIGS. 10(a) to 10(f) the impedance of the flow restrictor passage is altered by varying the width of the flow restrictor passage, it will be appreciated that there are a number of means for altering the impedance of the flow restrictor passage. Where there is a geometric relationship between the shape of the manifold chamber and the flow restrictor passage, such as where both elements extend the length of the array of fluid chambers and where the flow restrictor passage is shaped such that it appears as a narrow, elongate passage leading from the manifold chamber, when viewed in cross-section in the array direction, it may be expected that similar flow patterns to those described above with reference to FIGS. 10(a) to 10(f) may be experienced.

Thus, providing such a flow restrictor passage where the impedance is greater than 42 MPa/m³s⁻¹ and/or less than 716 MPa/m³s⁻¹ may be generally advantageous in terms of flow properties where such geometry is present, for the reasons discussed above. Similarly, providing a flow restrictor passage where the ratio of the impedance over its length to the impedance over the length of the manifold chamber is greater than 1:85 and/or less than 4:3 may also be advantageous more generally in embodiments with such geometry.

Further, it should be noted that, as briefly discussed above, protrusions or baffles may be provided within flow restrictor passages to achieve such impedances and/or pressure drops. In addition, rather than varying the width of the flow restrictor passage, the length and, more generally, the shape of the flow restrictor passage may be altered instead. In particular, serpentine, or curved paths for the flow restrictor passage may be utilised, or ribs or ridges may be provided adjacent the flow restrictor passage, defining the shape of the passage.

Further details of the manifold chambers of the printhead of FIGS. 7, 8 and 9 are shown in FIG. 11, which is a side view, taken perpendicular to the array direction (100), of the component in which the manifold chambers are formed.

FIG. 11 shows an ink inlet conduit (36), which is connected to the inlet manifold chamber (18) at one longitudinal end thereof. There is also shown an ink outlet conduit (42), which is connected to the outlet manifold chamber (19) at the opposite longitudinal end. This causes the flow (21) in the inlet manifold chamber (18) to be directed in substantially the opposite direction to the flow (22) in the outlet manifold chamber (19), as shown in FIG. 9 and discussed above.

As may also be seen, both the manifold chambers (18, 19) are tapered with respect to the array direction (100), though in opposite senses. This assists in ensuring that the same rate of flow is provided for all chambers within the array (14). In an optional modification, one or both of the flow restrictor passages (28, 32) might be tapered instead, or in addition.

In addition, providing a taper within the manifold chambers (18, 19) may assist with purging of the fluid chambers as part of a start-up mode for the apparatus. For example, the taper may ensure a roughly equal amount of fluid flow passes through each of the chambers in the array. This may, for example, reduce the likelihood of bubbles being trapped at the end of the array furthest from the point where enters the manifold.

During use of the printhead shown in FIGS. 8, 9 and 11, the inlet and outlet conduits (36, 42) will be connected to a fluid supply system. Suitably, the ink supply system may apply a positive fluid pressure at the pipe connected as an inlet pipe and a negative pressure at the pipe connected as an outlet pipe, so as to drive a constant flow through the printhead. The magnitude of the negative pressure may be somewhat greater than the magnitude of the positive pressure, so that a negative pressure (with respect to atmospheric pressure) is achieved at the nozzles, which may prevent fluid “weeping” from the nozzles during use.

It will be appreciated that, while in the embodiment of FIG. 11 the inlet and outlet conduits (36,42) are connected at opposite ends to the inlet and outlet manifold chambers (19,18) respectively, in other embodiments the conduits (36,42) could connect to the respective manifold chambers at other points along their lengths. In such embodiments, the cross-sectional area of each manifold chamber may still be tapered with increasing distance in the array direction (100) from the point at which the conduit opens into the manifold chamber. Further, in an optional modification of the embodiment of FIG. 11, both conduits (36,42) may be provided at the same end of the respective one of the manifold chambers (19,18). An example of such an embodiment is shown in FIG. 12, which is an isometric view of a manifold component where both conduits (36, 42) are provided at the same end.

FIG. 13, which displays only certain interior components of the printhead of FIGS. 7, 8, 9 and 11, shows the configuration of the substrate member (86) more clearly. In particular, the conductive tracks (192), which connect the channel wall electrodes to drive circuitry (84) and which are formed on the side surfaces (34) of the substrate member (86), are clearly displayed in the drawing. In addition, the top surface of the strip of piezoelectric material, in which the fluid chambers are formed, is clearly visible in the drawing, as is the mounting surface, to which the nozzle plate (16) is attached. FIG. 13 further illustrates a printed circuit board having a number of electronic components provided thereupon and to which the drive circuitry (84) mounted on the side surfaces (34) of the substrate (86) are connected by means of flexible connector. The printed circuit board is generally planar and extends in the array direction (100) and the ejection direction (101). By providing the printed circuit board behind the nozzle plate (16) (when viewed in the ejection direction (101)) the printhead may be particularly compact.

FIG. 14 illustrates the fully assembled printhead (11), whose internal components are shown in FIGS. 7 to 9 and 11 and 13. Owing to the relatively small thickness of the nozzle plate (16), the top surface of the piezoelectric strip, in which the array of ejection chambers (14) is formed, is visible therethrough.

While the foregoing embodiments have made use of an actuator block where piezoelectric actuator elements are provided by elongate piezoelectric wall elements that separate successive elongate channels, it will be understood that the present invention may be applied more broadly. Specifically, a variety of piezoelectric actuator elements may be utilised, such as those formed using thin-film techniques (for example, sol gel, or vapour deposition) and incorporated in a MEMS device. In more detail, such thin-film techniques may be utilised to provide an array of piezoelectric actuator elements on the edge surface of the substrate member, though it will of course be appreciated that this particular geometry is by no means essential for implementing the present invention in a MEMS device. As in embodiments discussed above with reference to the figures, thin-film piezoelectric actuator elements may be electrically connected to drive circuitry using interconnector tracks provided on the side surfaces of the substrate member.

It will be understood that, particularly with such elements, it is not necessary for the piezoelectric actuator elements to form a wall of the corresponding fluid chamber.

For example, diaphragm-type piezoelectric actuators may be utilised, which each include a body of piezoelectric material mounted on a diaphragm member that bounds a portion of a corresponding one of the fluid chambers. The body of piezoelectric material is then actuable in response to electrical signals to cause the deformation of said diaphragm member so as to vary the volume of said corresponding one of the fluid chambers. The diaphragm member may be generally planar and may be supported around a portion of, or substantially all of, a perimeter, while being substantially unsupported within said perimeter. In some constructions the diaphragm member will also bound a further chamber, in which the body of piezoelectric material is located.

While the foregoing embodiments have included only one array of fluid chambers with a single inlet manifold chamber and a single outlet manifold chamber, it should be appreciated that the present invention may be embodied in constructions having several arrays of fluid chambers. In such embodiments, multiple inlet and/or outlet manifold chambers may be provided; according to the present invention, a flow restrictor passage connects one of these arrays of chambers to one of the inlet manifold and/or outlet manifolds.

For example, in a similar manner to the prior art constructions described with reference to FIGS. 1 to 6 two arrays of fluid chambers may be utilised. In such an embodiment, as with the constructions of FIGS. 1 to 6, a single, central inlet manifold chamber may be provided between two outlet manifold chambers. According to the present invention, this central inlet manifold may be connected to both arrays of fluid chambers with a single flow restrictor passage, or alternatively, respective flow restrictor passages can connect the inlet manifold to each array of fluid chambers.

It should further be appreciated that the principles discussed above with regard to the flow restrictor passages may also be applied to apparatus having only an inlet manifold (so that there is no outlet manifold). In such embodiments, the flow restrictor passage will nonetheless present sufficient impedance to fluid flow such that, in use, fluid within the flow restrictor adjacent the array of chambers is directed generally perpendicular to the array direction for substantially all the chambers within the array.

Further, while the foregoing embodiments have concerned an inkjet printhead, as noted above, a variety of alternative fluids may be deposited by droplet deposition apparatus. Thus, where reference is made above to an inkjet printhead this should be understood only as giving a particular example of a droplet deposition apparatus.

1.-61. (canceled)

62. A droplet deposition apparatus comprising:
an array of fluid chambers, each chamber being provided with a nozzle and at least one piezoelectric actuator element operable to cause the release, on demand, of a droplet of fluid from the chamber through the nozzle in an ejection direction, the array extending in an array direction, substantially perpendicular to said ejection direction;
a common inlet manifold extending at least substantially the length of said array and being elongate in said array direction, for supplying fluid to said array of chambers;
a common outlet manifold extending at least substantially the length of said array and being elongate in said array direction, for receiving fluid from said array of chambers; and
a first flow restrictor passage connecting said array of chambers to one of said common inlet manifold and said common outlet manifold, so as to enable, respectively: a flow of fluid during use of the apparatus along the length of said common inlet manifold, through said first flow restrictor passage, then through said array of fluid chambers, and then into and along the length of said common outlet manifold; or a flow of fluid during use of the apparatus along the length of said common inlet manifold, through said array of fluid chambers, then through said first flow restrictor passage, and then into and along the length of said common outlet manifold;
wherein said first flow restrictor passage extends substantially the length of said array in said array direction;
wherein said one of the common inlet manifold and the common outlet manifold, and said first flow restrictor passage are shaped such that, when a cross-section taken perpendicular to the array direction is considered, said first flow restrictor passage appears as a narrow, elongate passage leading from or to respectively said one of the common inlet manifold and the common outlet manifold; and
wherein said first flow restrictor passage presents sufficient impedance to fluid flow such that, in use, fluid within said first flow restrictor passage adjacent said array of chambers is directed generally perpendicular to said array direction for substantially all the chambers within the array.

63. Apparatus according to claim 62, wherein said first flow restrictor passage is elongate in said ejection direction.

64. Apparatus according to claim 62, wherein the fluidic impedances of said first flow restrictor passage and said one of the common inlet manifold and the common outlet are such that the ratio of the fluidic impedance along the length of the first flow restrictor passage to the fluidic impedance along the length of said one of the common inlet manifold and the common outlet manifold is greater than 1:85 and/or less than 4:3.

65. Apparatus according to claim 62, wherein the fluidic impedances of said first flow restrictor passage and said array of fluid chambers are such that the ratio of the pressure drop along the length of the first flow restrictor passage to the pressure drop across the array of fluid chambers is greater than 1:450 and/or is less than 1:15.

66. Apparatus according to claim 62, wherein each of said fluid chambers is elongate in a chamber extension direction, which is perpendicular to said ejection direction.

67. Apparatus according to claim 61, further comprising a substrate member that extends beyond both ends of the array of fluid chambers in said array direction and, when viewed in cross-section perpendicular to said array direction, is elongate in said ejection direction, wherein said piezoelectric actuator members are provided on an edge surface of said substrate member, the edge surface extending in a plane normal to said ejection direction.

68. Apparatus according to claim 67, wherein said substrate member includes a first side surface extending in said array direction and said ejection direction;
further comprising an array of electrical interconnectors provided on said first side surface, said electrical interconnectors providing, at least in part, electrical connection between drive circuitry and said piezoelectric actuator elements.

69. Apparatus according to claim 68, wherein said drive circuitry is provided on said first side surface.

70. Apparatus according to claim 68, wherein said first side surface bounds a portion of said first flow restrictor passage.

71. Apparatus according to claim 62, wherein each of said piezoelectric actuator members ether: comprises a wall comprising piezoelectric material that separates neighbouring chambers within said array; or
comprises a body of piezoelectric material mounted on a diaphragm member that bounds a portion of a corresponding one of said fluid chambers, said body of piezoelectric material being actuable to cause the deformation of said diaphragm member so as to vary the volume of said corresponding one of the fluid chambers.

72. Apparatus according to claim 62, further comprising a second flow restrictor passage connecting said array of chambers to the other of said common inlet manifold and said common outlet manifold, so as to enable a flow of fluid during use of the apparatus along the length of said common inlet manifold, through one of said first and second flow restrictor passages, then through said array of fluid chambers, then through the other of said first and second flow restrictor passages and then into and along the length of said common outlet manifold;
wherein said other of the common inlet manifold and the common outlet manifold, and said second flow restrictor passage are shaped such that, when a cross-section taken perpendicular to the array direction is considered, said second flow restrictor passage appears as a narrow, elongate passage leading from or to respectively said other of the common inlet manifold and the common outlet manifold; and
wherein said second flow restrictor presents sufficient impedance to fluid flow such that, in use, fluid within said second flow restrictor adjacent said array of chambers is directed generally perpendicular to said array direction for substantially all the chambers within the array.

73. Apparatus according to claim 72, wherein said second flow restrictor passage is elongate in said ejection direction.

74. Apparatus according to claim 62, further comprising a cover member in which said nozzles are formed, said cover member being substantially planar and extending in a plane normal to said ejection direction, said cover member bounding a portion of said first flow restrictor passage.

75. Apparatus according to claim 74, wherein the portion of said first flow restrictor passage bounded by said cover member is an end portion of said first flow restrictor passage, located adjacent to said array of fluid chambers.

76. A droplet deposition apparatus comprising:
an array of fluid chambers, each chamber being provided with a nozzle and at least one piezoelectric actuator element operable to cause the release, on demand, of a droplet of fluid from the chamber through the nozzle in an ejection direction, the array extending in an array direction, substantially perpendicular to said ejection direction;
a common inlet manifold for supplying fluid to said array of chambers, the common inlet manifold extending substantially the length of said array and being elongate in said array direction, so as to enable a flow of fluid during use of the apparatus along the length of said common inlet manifold; and
a flow restrictor passage connecting said common inlet manifold to said array of chambers, the flow restrictor passage extending substantially the length of said array in said array direction;
wherein said common inlet manifold and said flow restrictor passage are shaped such that, when a cross-section taken perpendicular to the array direction is considered, said flow restrictor passage appears as a narrow, elongate passage leading from the common inlet manifold; and
wherein said flow restrictor presents sufficient impedance to fluid flow such that, in use, fluid within said flow restrictor adjacent said array of chambers is directed generally perpendicular to said array direction for substantially all the chambers within the array.

77. Apparatus according to claim 76, wherein said flow restrictor passage is elongate in said ejection direction.

78. Apparatus according to claim 76, wherein the fluidic impedances of said flow restrictor passage and said common inlet manifold are such that the ratio of the fluidic impedance along the length of the flow restrictor passage to the fluidic impedance along the length of said one of the common inlet manifold and the common outlet manifold is greater than 1:85 and/or less than 4:3.

79. Apparatus according to claim 76, wherein the fluidic impedances of said flow restrictor passage and said array of fluid chambers are such that the ratio of the pressure drop along the length of the flow restrictor passage to the pressure drop across the array of fluid chambers is greater than 1:450 and/or is less than 1:15.

80. Apparatus according to claim 76, wherein each of said fluid chambers is elongate in a chamber extension direction, which is perpendicular to said ejection direction.

81. Apparatus according to claim 76, further comprising a substrate member that extends beyond both ends of the array of fluid chambers in said array direction and, when viewed in cross-section perpendicular to said array direction, is elongate in said ejection direction, wherein said piezoelectric actuator members are provided on an edge surface of said substrate member, the edge surface extending in a plane normal to said ejection direction.

82. Apparatus according to claim 81, wherein said substrate member includes a first side surface extending in said array direction and said ejection direction;
further comprising an array of electrical interconnectors provided on said first side surface, said electrical interconnectors providing, at least in part, electrical connection between drive circuitry and said piezoelectric actuator elements.

83. Apparatus according to claim 82, wherein said drive circuitry is provided on said first side surface.

84. Apparatus according to claim 82, wherein said first side surface bounds a portion of said flow restrictor passage.

85. Apparatus according to claim 76, wherein each of said piezoelectric actuator members either: comprises a wall comprising piezoelectric material that separates neighbouring chambers within said array; or
comprises a body of piezoelectric material mounted on a diaphragm member that bounds a portion of a corresponding one of said fluid chambers, said body of piezoelectric material being actuable to cause the deformation of said diaphragm member so as to vary the volume of said corresponding one of the fluid chambers.

86. Apparatus according to claim 76, further comprising a cover member in which said nozzles are formed, said cover member being substantially planar and extending in a plane normal to said ejection direction, said cover member bounding a portion of said flow restrictor passage.

87. Apparatus according to claim 86, wherein the portion of said flow restrictor passage bounded by said cover member is an end portion of said flow restrictor passage, located adjacent to said array of fluid chambers.

88. Apparatus according to claim 72, further comprising a cover member in which said nozzles are formed, said cover member being substantially planar and extending in a plane normal to said ejection direction, said cover member bounding an end portion of said first flow restrictor passage, which is located adjacent to said array of fluid chambers, and an end portion of said second flow restrictor passage, which is located adjacent to said array of fluid chambers.

89. Apparatus according to claim 88, wherein each of said first flow restrictor passage and said second flow restrictor passage is elongate in said ejection direction.
